(19) United States
(12) Patent Application Publication
(10) Pub. No.: US 2007/0086729 A1
(43) Pub. Date: Apr. 19, 2007

(54) Method for reproducing data of optical disc

(75) Inventor: Jin Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/476,829

(22) Filed: Jun. 29, 2006

(30) Foreign Application Priority Data
Oct. 17, 2005 (KR) 2005-97785

(51) Int. Cl. H04N 7/00

(52) U.S. Cl. 386/95

(57) ABSTRACT

A method of reproducing data of an optical disc. The method corrects time information of an optical disc unsuitable for a prescribed standard using a Presentation Time Stamp (PTS) value of a predetermined area of the optical disc in which data is recorded according to other than a predetermined standard, and the method reproduces data of the optical disc. The method of reproducing data of the optical disc includes: when an optical disc is seated, reproducing data of a specific area of the optical disc, and reading a Presentation Time Stamp (PTS) value; calculating a ratio (L2P) of the PTS value read from the optical disc and a PTS value suitable for a predetermined standard; and correcting time information of the optical disc using the calculated L2P ratio, and reproducing the data including the corrected time information.

### CROSS-REFERENCE TO RELATED APPLICATION

This application claims the benefit of Korean Application No. 2005-97785, filed Oct. 17, 2005, in the Korean Intellectual Property Office, the entire content of which is incorporated herein by reference.

### BACKGROUND OF THE INVENTION

1. Field of the Invention

Aspects of the present invention relate to a method of reproducing data of an optical disc, and more particularly, to a method of correcting a time information of an optical disc unsuitable for a prescribed standard using a Presentation Time Stamp (PTS) value of a predetermined area of the optical disc in which data is recorded according to other than the predetermined standard, and reproducing data of the optical disc.

2. Description of the Related Art

Generally, in order to record a desired image in an optical disc, video/audio data of the desired image is compressed and recorded according to a predetermined standard. Similarly, to reproduce the desired image from the optical disc, the video/audio data of the desired image is transmitted and decoded, such that the decoded data is reproduced in the form of video/audio data.

A Video Compact Disc (VCD) compresses video/audio data according to a Moving Picture Experts Group (MPEG) format. The audio/video signals compressed by the MPEG format are Time-Division-Multiplexed (TDM), the TDM audio/video signals are divided into packets, such that the packets of the audio/video signals are recorded or transmitted.

In the case of the aforementioned multiplexing caused by the packets, an encoder divides a video or audio signal into a bit stream of a predetermined length to construct each packet of data, hereinafter referred to as packet data, and includes additional information (e.g., data category information, and data size information, etc.) in a header of each packet data, such that the resultant packet data is recorded and/or transmitted. The decoder analyzes the header of the packet data, decodes each packet data into video or audio data according to a Decoding Time Stamp (DTS) contained in the packet header, and displays each video/audio data according to a Presentation Time Stamp (PTS).

VCD, in which data is compressed and stored according to a predetermined VCD standard, calculates a time of a desired part because the standard is based on a standard reproduction rate of storage sectors per second, such that to reproduce data of the desired part, the time is determined, a search for an address of the desired part using a Time Search function is executed, and data of the desired part is reproduced. Also, the VCD can perform a Resume function after data reproduction of the desired part is terminated. For example, when 75 sectors are assigned to 1 second and 10 minutes elapse, a sector corresponding to the 10 minute mark is calculated by a predetermined equation of 10×60×75=sector 45,000. In this case, the calculated sector may be equal to a PTS indicative of a reproduction time of packet data, so that the reproduction time shown is very close to the time calculated according to the standard.

A VCD manufactured by a user, a non-standardized VCD or an unauthorized VCD (hereinafter non-standard VCD) unsuitable for a predetermined specification may store video data of about one hour. Therefore, when a playback point moves in such a VCD according to a predetermined standard, a PTS value of the playback point will be less than (or greater than) a reference PTS value associated with the predetermined standard. As a result, if a playback or reproduction time of a specific part desired by the user is detected on the non-standard VCD according to the predetermined standard, there is a disadvantage in that the detected reproduction time is unavoidably shorter (or longer) than an actual reproduction time of the desired part.

In association with the Resume function, an address of a halt area at which data reproduction from the non-standard VCD stops is stored on the basis of a reproduction time acquired by the PTS detected according to the predetermined standard and described above, such that data of an erroneous part of the non-standard VCD different from the above actual halt area may be reproduced by the Resume function.

### SUMMARY OF THE INVENTION

Therefore, it is an aspect of the invention to provide a method for reading some PTS information from an optical disc in which data is recorded according to other than a predetermined standard, correcting time information of the optical disc, and reproducing data of the corrected time information from the optical disc.

Additional aspects and/or advantages of the invention will be set forth in part in the description which follows and, in part, will be obvious from the description, or may be learned by practice of the invention.

In accordance with aspects of the invention, the above and/or other aspects can be achieved by the provision of a method for reproducing data from a seated optical disc comprising: reproducing data of a specific area of the optical disc, and reading a Presentation Time Stamp (PTS) value; calculating a ratio (L2P) of the PTS value read from the optical disc and a PTS value suitable for a predetermined standard; and correcting time information of the optical disc using the calculated L2P ratio, and reproducing data including the corrected time information.

According to a preferable aspect of the present invention, the PTS value of the optical disc is read several times and a mean value of the read PTS value is calculated, and then the L2P ratio is calculated by the mean value.

According to a preferable aspect of the present invention, the read PTS values are contained in a predetermined range on the basis of the PTS value suitable for the standard in the reproduced area, such that the mean value is calculated using only the PTS values contained in the predetermined range.

According to a preferable aspect of the present invention, the method further comprises: comparing the calculated L2P ratio with a reference value, determining whether data is reproduced according to the standard of the optical disc, and determining whether the time information of the optical disc is corrected.

According to a preferable aspect of the present invention, the specific area of the optical disc is located at an intermediate area of the longest track from among a plurality of tracks of the optical disc.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a conventional VCD system;

FIG. 2 is a flow chart illustrating a method for reproducing data of a general VCD;

FIG. 3 is a graph illustrating a relationship between a PTS value of a VCD suitable for both a reproduction time and a prescribed standard and another PTS value of a non-standard VCD according to an embodiment of the present invention; and

FIG. 4 is a flow chart illustrating a method of reproducing data of an optical disc according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

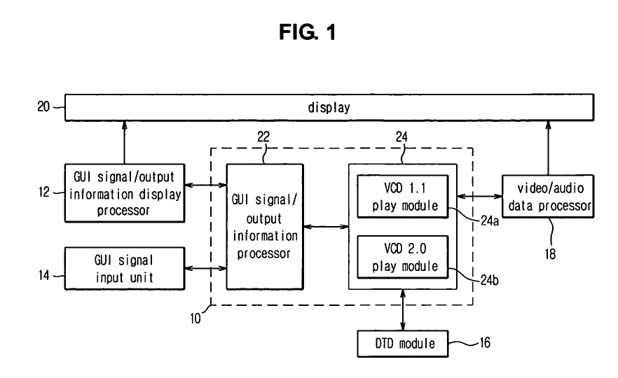

FIG. 1 is a block diagram illustrating a conventional VCD system. It is understood that VCD includes such embodiments as optical discs, DVDs, HD DVDs, Blu-ray discs, Advanced Optical Discs (AODs), flash drives, etc. Referring to FIG. 1, the VCD system includes a VCD data processing system 10, a GUI (Graphical User Interface) signal input unit 14, a GUI signal/output information display processor 12, and a video/audio data processor 18. The VCD data processing system 10 analyzes a user command received from the GUI signal input unit 14, transmits a control signal for an OSD (On Screen Display) function to the GUI signal/output information display processor 12, and controls a VCD play module 24. The VCD play module 24 includes a VCD 1.1 play module 24a for decoding data of a VCD 1.1 standard, and a VCD 2.0 play module 24b for decoding data of a VCD 2.0 standard. When the VCD is seated in a DTD module 16, a variety of VCD information (e.g., start and end addresses of each track) are recognized from a Lead-in area of the VCD. The video/audio data processor 18 synchronizes each data decoded by the VCD play module 24 with PTS information, and displays the synchronization result on the display 20.

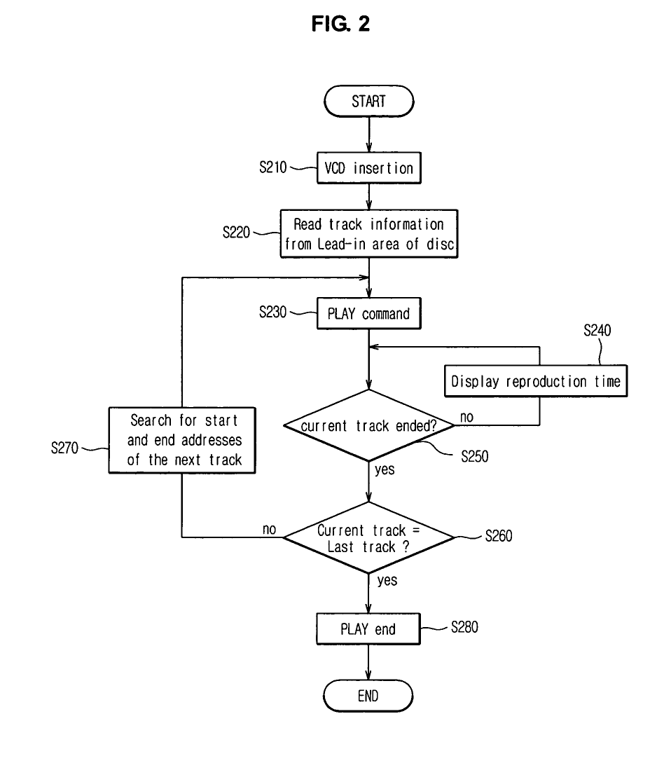

VCD operations based on the aforementioned configuration will hereinafter be described with reference to FIG. 2. FIG. 2 is a flow chart illustrating a method for reproducing data of a general VCD.

Referring to FIG. 2, when a VCD is seated in an apparatus for reproducing data of an optical disc at operation S210, the DTD module 16 of the apparatus acquires start and end address information of individual tracks contained in the VCD from the Lead-in area of the optical disc at operation S220. The apparatus can recognize length and total reproduction time information of individual tracks at operation S220. When a user enters a reproduction signal, the apparatus enters a command (i.e., a PLAY command) for reproducing data of a first track at operation S230. Data entered by an optical pickup unit (not shown) is applied to the VCD play module 24, and is decoded according to the standard version information, such that the decoded data is transmitted to the video/audio data processor 18. The DTD module 16 detects a current address while data of the optical disc is reproduced, compares the detected address with the end address of the track including the reproduced data. When data reproduction of the track is not terminated, the apparatus displays a current reproduction time using PTS information detected by the video/audio data processor 18 at operations S240 to S250. When data reproduction of a current track is terminated, the apparatus determines whether the current track is equal to the last track S260. When the current track is different from the last track, the apparatus searches for start and end addresses of the next track to reproduce data of the next track, and enters a play command of the next track at operation S270. When data reproduction of the last track is completed, the play command is terminated at operation S280.

Video/audio data of a moving image is compressed and stored according to a TDM scheme. The video data of the moving image is decoded by the video decoder, and the audio data of the moving image is decoded by the audio decoder. The decoded video/audio data is synchronized by a PTS, and is reproduced according to the synchronization. The PTS includes time information indicative of display times of individual frames of the video/audio data. The GUI signal/output information display processor 12 displays a reproduction time on the display 20 using the aforementioned time information.

The VCD, in which data is stored according to a general standard, includes a predetermined sector size per unit of time (e.g., 75 sectors per second) based on the reproduction rate of the standard, and provides PTS data by multiplying a predetermined temporal sector by a constant. Therefore, the VCD, in which data is stored according to the standard, has no difference between a part retrieved by a Time Search command entered by the user and the PTS time information of the retrieved part. In association with a VCD in which data unsuitable for the predetermined standard is stored such that many moving images are stored in the optical disc, a PTS value of the part retrieved by the Time Search function is less than a reference PTS value based on the standard as previously described. The reason that the PTS value of the retrieved part is less than the reference PTS value is that a sector may be shorter (e.g., 100 sectors per second) than that of the standard (e.g., 75 sectors per second), and other factors may contribute to encountering the aforementioned problem.

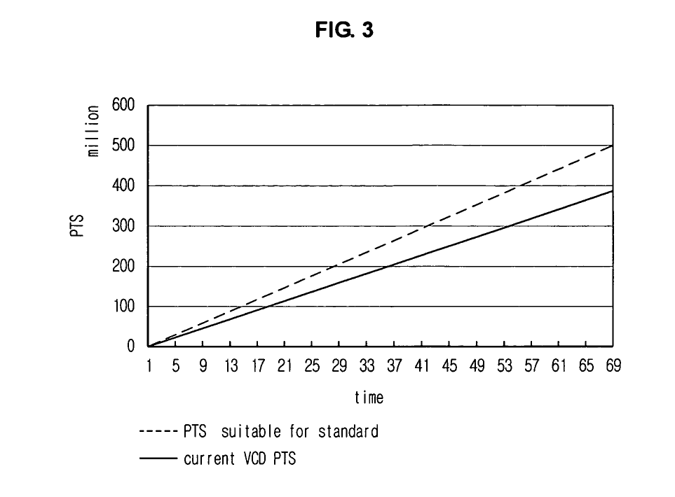

FIG. 3 is a graph illustrating a relationship between a PTS value of a VCD suitable for both a reproduction time and a prescribed standard and another PTS value of a non-standard VCD.

Referring to FIG. 3, a dotted line is indicative of a first group of PTS values suitable for the standard and a solid line is indicative of a group of second PTS values of a current VCD in which data unsuitable for the standard is stored. The second group of PTS values of the current VCD synchronizes display times of individual frames of the video/audio data, and increase at a predetermined rate in proportion to a reproduction time. Therefore, although there is a little difference between the individual increasing rates of the first and second PTS values, slopes of the first and second groups of PTS values versus reproduction time in the individual VCDs are constant. An aspect of the present invention uses the aforementioned characteristics of the first and second groups of PTS values, reproduces data of a predetermined area of the current VCD according to the standard, reads the PTS information of the predetermined area, and calculates a specific ratio of the standard PTS value to the read PTS value (L2P) associated with the PTS value. Thereafter, the read PTS values are multiplied by the aforementioned ratio (L2P), and the time information of the current VCD is corrected, such that a reproduction time is displayed and a Resume function can be implemented. For example, when reading data of a specific part corresponding to 20 minutes, a reproduction point moves to a sector corresponding to the aforementioned specific part, a predetermined constant is multiplied by 20×60×75, such that the PTS value (i.e., the first PTS value) suitable for the standard is calculated, and the PTS value (i.e., the second PTS value) of the current VCD is read several times. Preferably, the second PTS value may be read four or five times because an optical pickup unit may read an incorrect PTS value, such that a mean value of the read PTS values may be selected. It is then determined whether a difference between the mean read PTS value and the calculated standard PTS value is equal to or less than an allowable error (e.g., 10 seconds). When it is determined that the difference between the PTS values is equal to or less than the allowable error, then the video/audio data of the current VCD is normally reproduced according to the standard. Otherwise, when it is determined that the difference between the PTS values is higher than the allowable error range, time information of data is corrected, such that corrected data is reproduced.

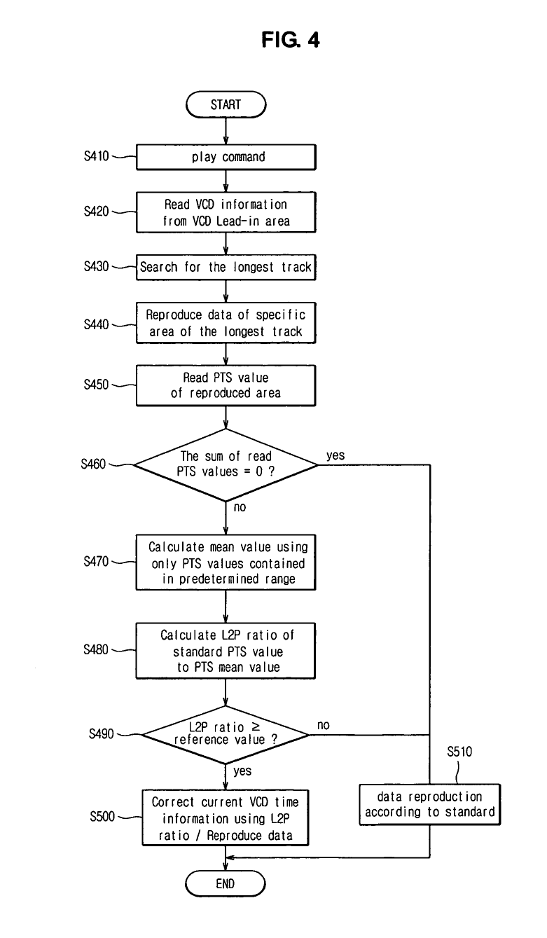

FIG. 4 is a flow chart illustrating a method for reproducing data of an optical disc according to aspects of the present invention.

Referring to FIG. 4, when a VCD is seated in the apparatus for reproducing data of the optical disc and a user enters a reproduction command (i.e., a PLAY command) at operation S410, the apparatus acquires information of individual tracks of the VCD from the Lead-in area of the VCD at operation S420. When a plurality of tracks exist in the VCD, the apparatus searches for the longest track from among the tracks at operation S430, such that it reproduces data of a specific part of the longest track at operation S440. In this case, when data of an intermediate area of the longest track is reproduced, a PTS value can be easily read. The PTS value of the reproduced area is read a predetermined number of times at operation S450. In this case, the apparatus calculates the sum of the read PTS values, such that it can determine whether the optical pickup unit successfully reads the PTS value. When the sum of the read PTS values is zero at operation S460, it is determined that the optical pickup unit erroneously reads the PTS value. In this case, although the optical pickup unit may re-attempt to read the PTS value, it should be noted that the optical pickup unit has difficulty in successfully reading the PTS value. Therefore, when the optical pickup unit fails to read the PTS value at operation S460, the apparatus reproduces data according to the standard at operation S510. When the sum of the read PTS values is not zero at operation S460, then read PTS values within a predetermined range of a reference PTS value calculated according to the standard, are selected and a mean value of the selected PTS values is calculated, such that an erroneous PTS value can be detected at operation S470. The ratio (L2P) of the PTS value suitable for the standard to the mean value of the read PTS values is calculated at operation S480, and the calculated value is compared with the individual reference value at operation S490. When a VCD includes data suitable for the standard, the ratio may be set to a specific value of 1, or may be contained in an allowable error range. In order to reduce the number of additional calculations required for data correction, when the difference between total reproduction times based on the PTS values of the first and second groups is less than a predetermined time (e.g., 10 seconds), there will be no problem when the current VCD data is reproduced according to the standard. When the aforementioned ratio (L2P) is outside the allowable range, such as higher than a reference value (e.g., 1.02 seconds), time information of a current VCD is corrected by the L2P, such that data including the corrected time information is reproduced at operation S500.

For example, when a user enters 10 seconds using the Time Search function, the VCD system calculates the value of 10×60×75, and enters a command for reproducing data of a sector corresponding to the calculated value in accordance with the standard. When a PTS value is read after data reproduction is terminated, the read PTS value may be less than the standard value. The aforementioned ratio (L2P) is multiplied by the read PTS value, and a data reproduction time is calculated by the multiplied resultant value. The calculated data reproduction time is displayed on the display. In this case, the aforementioned correction process allows the calculated data reproduction time to be equal to or less than the standard value, within an allowable error range, on the basis of an input time. In association with the Resume function, a current address is stored on the basis of a reproduction time when data reproduction is suspended, the aforementioned ratio (L2P) is multiplied by a PTS value read from the suspended area, a start address of a currently reproduced track is added to the multiplied result, and the resultant value is stored.

As is apparent from the above description, an aspect of the present invention acquires PTS information by reproducing data of a specific area of an optical disc, and corrects time information of a VCD unsuitable for a predetermined standard using the acquired PTS information, such that the Time Search function and the Resume function can be correctly performed.

While not required in all aspects, portions of the method can be implemented using computer software and/or firmware encoded on one or more computer readable media to be implemented on one or more computers.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of reproducing data of an optical disc comprising:
when an optical disc is seated, reproducing data of a specific area of the optical disc, and reading a Presentation Time Stamp (PTS) value;
calculating a ratio (L2P) of the PTS value read from the optical disc and a PTS value suitable for a predetermined standard; and
correcting time information of the optical disc using the calculated L2P ratio, and reproducing data including the corrected time information.

2. The method according to claim 1, wherein the L2P ratio, when the PTS value of the optical disc is read several times and a mean value of the read PTS value is calculated, is calculated using the mean PTS value.

3. The method according to claim 2, wherein the read PTS values are contained in a predetermined range on the basis of the PTS value suitable for the standard in the reproduced area, such that the mean value is calculated using only the PTS values contained in the predetermined range.

4. The method according to claim 1, further comprising:
comparing the calculated L2P ratio with a reference value, determining whether data is reproduced according to the standard of the optical disc, and determining whether the time information of the optical disc is corrected.

5. The method of claim 4, wherein when the calculated L2P ratio is equal to the reference value within an allowable error range, the data is determined to be reproduced according to the standard of the optical disc.

6. The method according to claim 1, wherein the specific area of the optical disc is located at an intermediate area of the longest track from among a plurality of tracks of the optical disc.

7. The method of claim 2, wherein reproducing the data of the optical disc according to the standard when the read PTS value is zero.

8. A method of reproducing non-standard data from an optical disc comprising:
reproducing data of a specific area of the optical disc;
obtaining a non-standard Presentation Time Stamp (PTS) value at a specified portion of the reproduced data;
calculating a correction ratio (L2P) of a PTS value suitable for a predetermined standard at the specified portion of the reproduced data to the non-standard PTS value;
correcting a time information of the optical disc using the correction ratio L2P; and
reproducing data from the optical disc using the correction ratio L2P.

9. An optical disc reproduction system, comprising:
an optical pickup module to reproduce non-standard data from an optical disc;
a read module to obtain a non-standard Presentation Time Stamp (PTS) value at a specified portion of the reproduced data; and
a controller module to calculate a correction ratio (L2P) of a PTS value suitable for a predetermined standard at the specified portion of the reproduced data to the non-standard PTS value.

10. The optical disc reproduction system of claim 9, further comprising:
a corrector module to correct a time information of the optical disc using the correction ratio L2P; and
an output unit to reproduce data from the optical disc using the correction ratio L2P.

11. The optical disc reproduction system of claim 10, further comprising:
a display unit to display the reproduced corrected data and the corrected time information of the optical disc.

12. A method of reproducing non-standard data from an optical disc comprising:
reproducing data of a specific area of the optical disc;
acquiring Presentation Time Stamp (PTS) information of the specific area of the optical disc; and
correcting a time information unsuitable for a predetermined standard using the acquired PTS so a Time Search function and a Resume function can be correctly performed.
